(19) United States
(12) Patent Application Publication
(10) Pub. No.: US 2004/0198420 A1
(43) Pub. Date: Oct. 7, 2004

(54) RF front-end of dual-mode wireless transciver

(76) Inventors: Ziming He, Irvine, CA (US); Ping Peng, Irvine, CA (US); Nopakorn Hiranrat, Walnut, CA (US); Hung Tieu, Alhambra, CA (US); Yin Qian, Hacienda Hts., CA (US)

Correspondence Address: WEI TE CHUNG, FOXCONN INTERNATIONAL, INC., 1650 MEMOREX DRIVE, SANTA CLARA, CA, 95050, US

(21) Appl. No.: 10/225,808

(22) Filed: Aug. 21, 2002

(51) Int. Cl. H04B 1/38

(52) U.S. Cl. 455/552.1; 455/78; 455/553.1

(57) ABSTRACT

A dual-mode WLAN module includes two dual-band antennas (43a, 43b), an RF front-end circuit (4), a dual-mode radio frequency integrated circuit (RFIC) chip (3), a dual-mode Base-Band integrated circuit chip (2), and an interface (mini-PCI, PCI, USB etc.) connecting to a computer (1). The RF front-end circuit for dual-mode WLAN module comprises two transmitting circuits, two receiving circuits, switch units, and logic control circuit (40) for controlling the operation of transmitting/receiving selection and antenna diversity selection.

### CROSS-REFERENCE TO RELATED APPLICATION

This application relates to a co-pending U.S. patent application with an unknown serial number, entitled “RF FRONT-END FOR DUAL-MODE WIRELESS LAN MODULE”, invented by the same inventors, filed on the same date, and assigned to the same assignee as the present invention.

### BACKGROUND OF THE INVENTION

1. Field of the Invention

The present invention relates to a radio frequency (RF) front-end design, and more particularly to an RF front-end design employed in a dual-mode Wireless Local Area Network (WLAN) module.

2. Description of the Prior Art and the Related Art

Wireless Local Area Network (WLAN) technology continues to advance in performance achieving Ethernet-like data rates. It is becoming more and more commonly used to service a variety of voice and data applications in the 2.4 GHz Industrial, Scientific and Medical (ISM) band. A paper, entitled “Technology economics of standards based WLAN solutions and cost of ownership” by Juan Figueroa, Bill Garon, Bob Pearson and Al Petrick of Intersil Corporation, analyzes cost of WLANs and concludes that the wireless technology and communication protocol proposed by the IEEE 802.11 Working Group is today already competitive with well established and mature technologies such as Ethernet. Further advances in RF silicon processes and in packaging technology, the paper claims, will enable the market to reach price levels that will make wireless LANs ubiquitous, and therefore the technology of choice.

There are an increasing number of wireless networking products becoming available on the market today, including Bluetooth devices, products based on the IEEE 802.11b standard, and also products based on proprietary standards, such as HomeRF. But they all suffer from associated problems that hold back widespread acceptance. The allocated spectrum around 2.4 GHz is narrow, and is shared not only by Bluetooth and other wireless networking devices, but also by microwave ovens and many other ISM devices. It really is a crowded frequency band.

More bandwidth can support more users reliably, which is important for the enterprise and office environment. IEEE 802.11b-based products have a frequency bandwidth of 83.5 MHz (2.4-2.4835 GHz) and only offer a maximum data rate of 11 Mbps, which is not enough. The allocated bandwidth in both the US and Europe at 5 GHz is about 300 MHz (5.15-5.35 GHz, 5.725-5.825 GHz), which is more than twice the space allocated at 2.4 GHz. The maximum data rate of 802.11a is up to 54 Mbps. The area of the spectrum is free from interference and the resulting data rates now compare with these in wired systems. Therefore, IEEE 802.11a operating at 5 GHz has developed into a new general standard.

Furthermore, more users hope to employ a WLAN terminal product which can operate both at 2.4 GHz and 5 GHz, rather than employ two different sets of products which respectively operate in different modes, because the latter has poor compatibility and mobility. To meet the trend, several Integrated Circuit (IC) design or semiconductor companies have developed dual-mode combo chipsets to support both 802.11a and 802.11b operation. Those already developing dual solutions include Envara Inc., Atheros Communications Inc., Synad Technologies Inc., Intel Inc., and others.

The current problem is how to design a complete product module with a dual-mode chipsets including interconnection among each chip, an interface to peripheral equipment, and a radio frequency (RF) front-end, wherein the RF front-end design is the key and most difficult part in the whole module design. U.S. Pat. Nos. 6,351,502 B1, and 6,205,171 B1 disclose several conventional RF front-ends or antenna interface units in wireless systems. However, neither of the two designs can adapt to a dual-mode WLAN module.

Hence, an RF front-end for a dual-mode WLAN module is required to overcome the disadvantages disclosed above.

### BRIEF SUMMARY OF THE INVENTION

A main object of the present invention is to provide a radio frequency (RF) front-end for a dual-mode Wireless Local Area Network (WLAN) module.

Another object of the present invention is to provide a dual-mode WLAN module compatible with both IEEE 802.11a and IEEE 802.11b standard WLAN.

A further object of the present invention is to provide a 802.11a/b dual-mode WLAN module for a mobile electronic device, such as a laptop computer.

A dual-mode WLAN module according to the present invention comprises two dual-band antennas, an RF front-end, a dual-mode radio frequency integrated circuit (RFIC) chip, a dual-mode base-band integrated circuit (BBIC) chip, and an interface (mini-PCI, PCI, USB etc.) connecting to a computer. The RF front-end for dual-mode WLAN module comprises two transmitting circuits, two receiving circuits, switch units, and logic control circuits for controlling the operation of Transmitting/Receiving selection and antenna diversity selection.

Other objects, advantages and novel features of the invention will become more apparent from the following detailed description when taken in conjunction with the accompanying drawings.

### BRIEF DESCRIPTION OF THE DRAWINGS

FIG. 1 is a block diagram of a dual-mode WLAN module in accordance with a first embodiment (first topology) of the present invention.

FIG. 2 is a block diagram of a dual-mode WLAN module in accordance with a second embodiment (second topology) of the present invention.

FIG. 3 is block diagram of a dual-mode WLAN module in accordance with a third embodiment (third topology) of the present invention.

### DETAILED DESCRIPTION OF THE INVENTION

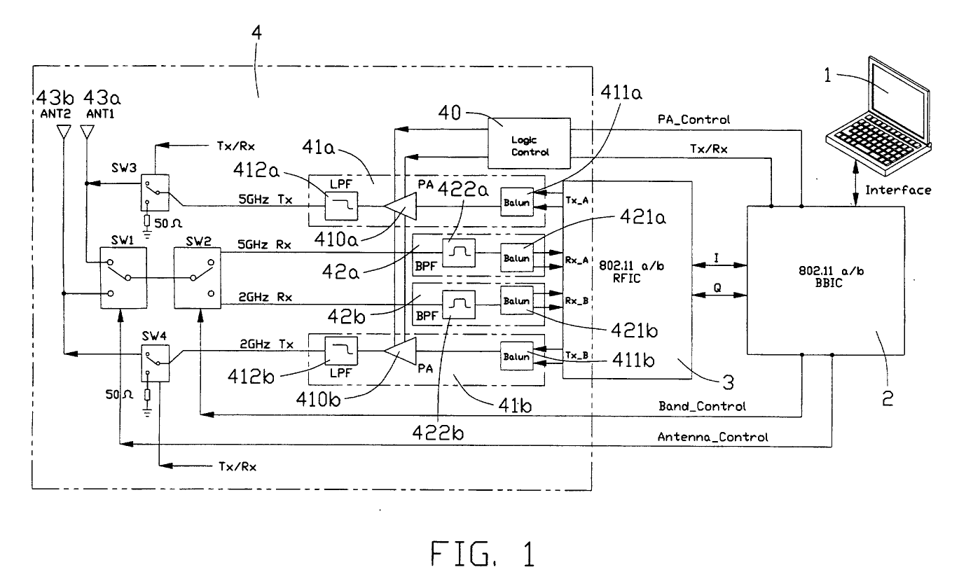

Referring to FIG. 1, a dual-mode (IEEE 802.11a/b) WLAN module in accordance with a first embodiment of the present invention, for installation in a laptop computer 1, comprises two dual-band antennas 43a, 43b, a radio frequency (RF) front-end circuit 4, a dual-mode radio frequency integrated circuit (RFIC) 3, a dual-mode base-Band integrated circuit (BBIC) 2, and an interface (mini-PCI, PCI, USB etc) connecting to the laptop computer 1.

In this embodiment, the interface connects to the dual-mode BBIC 2, the dual-mode BBIC 2 connects to the dual-mode RFIC 3, the dual-mode RFIC 3 connects to the RF front-end circuit 4, and the RF front-end circuit 4 connects to two dual-band antennas 43a, 43b.

The BBIC 2 has a signal receiving/transmitting selection pin (Tx/Rx), a band selecting pin (Band_Control) and an antenna selecting pin (Antenna_Control), and a power amplifier output level control pin (PA_Control). The RF front-end circuit 4 comprises a logic control unit 40, a first signal transmission processing unit 41a, a second signal transmission processing unit 41b, a first signal reception processing unit 42a, a second signal reception processing unit 42b, four Single Pole Double Throw (SPDT) switches SW1, SW2, SW3 and SW4, a first dual-band antenna 43a (2.4 GHz/5 GHz) and a second dual-band antenna 43b (2.4 GHz/5 GHz). SW1 and SW2 each has an operation frequency of DC to 6 GHz so that two frequency bands (2.4 to 2.4835 GHz and 5.15 to 5.825 GHz) are covered. The operation frequency of SW3 covers 5.15 to 5.825 GHz and the SW4 covers 2.4 to 2.4835 GHz.

The logic control unit 40 is controlled by the dual-mode BBIC 2. The first signal transmission processing unit 41a, which connects the dual-mode RFIC 3 with the SW3, comprises a Power Amplifier (PA) 410a, an RF balun 411a and a low-pass filter 412a. The second signal transmission processing unit 41b, which connects the dual-mode RFIC 3 with the SW4, also comprises a Power Amplifier (PA) 410b, an RF balun 411b and a low-pass filter 412b. The PAs 410a and 410b are both controlled by the logic control unit 40. The first and second signal reception processing units 42a and 42b connect the SW2 with the dual-mode RFIC 3, and each comprises an RF balun 421a, 421b and a band-pass filter 422a, 422b. The SW1 is controlled by the Antenna_Control signal, and couples the dual-band antennas 43a, 43b to the SW2. The SW2 is controlled by the Band_Control signal and couples the SW1 to the first and second signal reception processing units 42a and 42b. The SW3 is controlled by the Tx/Rx signal and couples the first signal transmission processing unit 41a to the first dual-band antenna 43a. The SW4 is also controlled by the Tx/Rx signal and couples the second signal transmission processing unit 41b to the second dual-band antenna 43b.

As described above, each of signal transmitting (Tx) paths (one for 5 GHz and another for 2.4 GHz) has only one switch (SW3 or SW4) and thus less insertion loss can be ensured.

As SW1 is controlled by the Antenna_Control signal and SW2 is controlled by the Band_Control signal, the signal receiving (Rx) path has antenna selection diversity. Furthermore, there is no RF signal path crossover problem in this topology, which makes it convenient for laying out the printed circuit board (PCB).

In this embodiment, the two dual-band antennas 43a, 43b can be identical and each covers two frequency bands: 2.4-2.4835 GHz and 5.15-5.825 GHz. When the WLAN module is put into the laptop computer 1, the two dual-band antennas 43a, 43b are located in different locations in the laptop computer 1. As antennas at different locations generally have different signal reception performance characteristics, the antenna selection diversity allows the BBIC to select the one of the two antennas which is receiving the signals most strongly. It is well known that antenna selection diversity on a signal receiving (Rx) path is more important than antenna selection diversity on a signal transmitting (Tx) path, since output signals tend to be much stronger than incoming signals. Therefore, antenna selection diversity for Tx path is not provided in this topology.

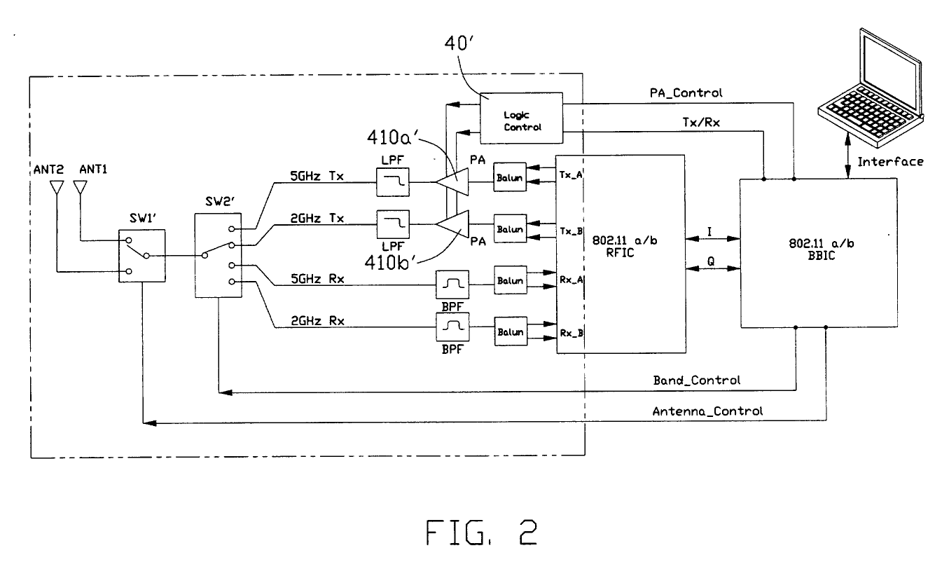

FIG. 2 shows a second RF front-end design topology for a dual-mode WLAN module, which is different from that shown in FIG. 1. In this topology both signal transmitting and receiving have antenna diversity selection ability. The SW1′ in FIG. 2 is the same as the SW1 in FIG. 1 (SPDT switch), but the SW2′ is a Single Pole Four Throw (SP4T) switch. Both switches have an operation frequency to cover the two frequency bands (2.4 to 2.4835 GHz and 5.15 to 5.825 GHz). The SW1′ is controlled by an antenna selecting pin (Antenna_Control) and the SW2′ is controlled by a band selecting pin (Band_Control). The signal transmitting (Tx) and receiving (Rx) paths are easily controlled by the SW2′. On the signal Tx path, when a Tx path is selected by SW2′, the Tx signal will not enter an Rx path and only one of the power amplifiers (PA) 410a′ or 410b′, controlled by a logical control unit 40′, will be selected to amplify a signal at a time. On the signal Rx path, when an Rx path is selected by SW2′, the Rx signal will not enter a Tx path, and thus good isolation between Tx and Rx is achieved. The combination of SW1′ and SW2′ provides antenna selection diversity on both the signal Tx and Rx paths.

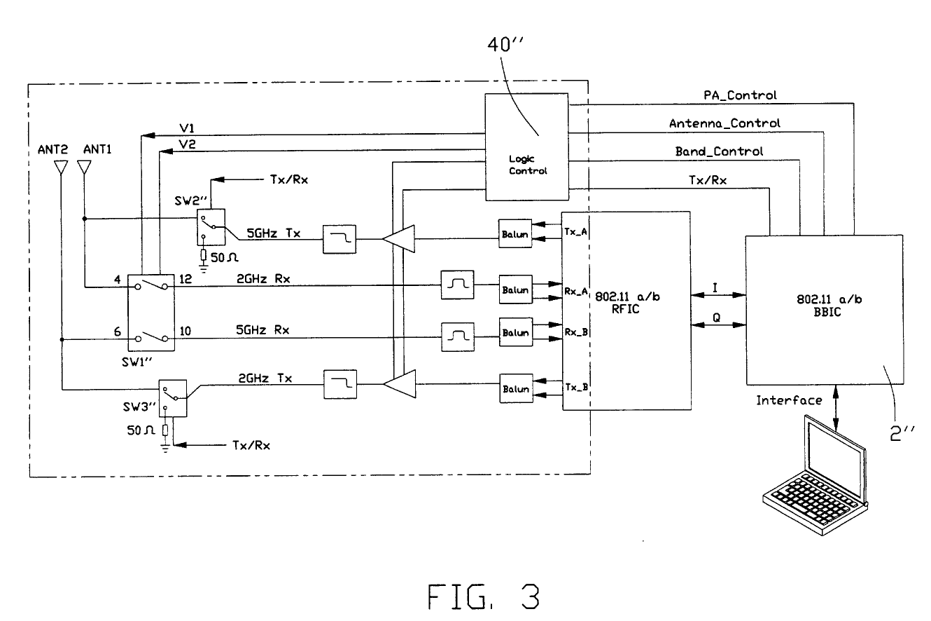

FIG. 3 shows a third RF front-end design topology for a dual-mode WLAN module. In this topology switches SW2″ and SW3″ are the same as the switches SW3 and SW4, respectively, in FIG. 1. However, the switch SW1″ in FIG. 3 is a Dual Pole Double Throw (DPDT) switch which simplifies the RF Front-End design. When the signal Tx path (controlled by the BBIC 2″) is ON, the switch SW1″ is controlled by the logic control unit 40″ so that pins 4-12 and 6-10 are connected, and thus the 5 GHz Tx signal will not go to the 5 GHz Rx path and the 2.4 GHz Tx signal will not go to the 2.4 GHz Rx path. Therefore, good isolation between the signal Tx and Rx paths can be achieved. When the signal Rx path (controlled by the BBIC 2″) is ON, the Tx paths are OFF, and the SW1″ is controlled by the logic control unit 40″ so that either pins 4-10 and 6-12 or 4-12 and 6-10 are connected, and thus the signal Rx path has antenna selection diversity. There is also no RF signal crossover problem in this design topology so that PCB layout design is facilitated.

While the present invention has been described with reference to a specific embodiment, the description is illustrative of the invention and is not to be construed as limiting the invention. Various modifications to the present invention can be made to the preferred embodiment by those skilled in the art without departing from the true spirit and scope of the invention as defined by the appended claims.

What is claimed is:

1. An antenna switch unit for receiving/transmitting first and second frequency band signals to/from a signal processing unit, comprising:
a first and second dual-band antennas;
a first switch unit for receiving the first and second frequency band signals from the antennas and communicating them to the signal processing unit; and
a second switch unit for transmitting the first and second frequency band signals from the signal processing unit to the first and second dual-band antennas.

2. The antenna switch unit as claimed in claim 1, wherein the first switch unit has antenna selection diversity.

3. The antenna switch unit as claimed in claim 1, wherein the operation frequencies of the first and second dual-band antenna cover 2.4 to 2.4835 GHz and 5.15 to 5.825 GHz.

4. A radio frequency (RF) front-end adapted to be employed in a dual-mode communication device, comprising:
a first and second dual-band antennas;
a signal receiving path for receiving two different frequency band RF signals comprising a first and a second signal reception processing units, and a first switch unit coupled to the first and second signal reception processing units and having antenna selection diversity for selecting one of the two different frequency band RF signals; and
a signal transmitting path for transmitting the two different frequency band signals comprising a first and a second signal transmission processing units, and a second switch unit coupled to the first and second dual-band antennas.

5. The RF front-end as claimed in claim 4, wherein the operation frequencies of the first and second dual-band antennas cover 2.4-2.4835 GHz and 5.15-5.825 GHz.

6. The RF front-end as claimed in claim 4, wherein the first switch unit comprises two switches connected with each other.

7. The RF front-end as claimed in claim 4, wherein the first switch unit is a Dual Pole Double Throw (DPDT) switch.

8. A radio frequency (RF) front-end adapted to be employed in a dual-mode communication device, comprising:
a first and second dual-band antennas;
a signal receiving path for receiving two different frequency band RF signals, the signal receiving path comprising a first and a second signal reception processing units;
a signal transmitting path for transmitting the two different frequency band RF signals, the signal transmitting path comprising a first and a second signal transmission processing units; and
a switch unit comprising a first and a second switches connected with each other;
wherein the first switch connects the first and second dual-band antennas with the second switch, and the second switch connects with the first and second signal reception and transmission processing units.

9. The RF front-end as claimed in claim 8, wherein the operation frequencies of the first and second dual-band antennas cover 2.4-2.4835 GHz and 5.15-5.825 GHz.

10. The RF front-end as claimed in claim 8, wherein the second switch is a Single Pole Four Throw (SP4T) switch.

11. The RF front-end as claimed in claim 8, wherein the first switch is a Single Pole Double Throw (SPDT) switch.

12. The RF front-end as claimed in claim 8, wherein the first and second switches commonly define four mutually exclusively different combinations under a condition that only one antenna is actively coupled with one corresponding signal reception unit in each of said combinations.

13. The RF front-end as claimed in claim 8, wherein the first and second switches commonly defines eight mutually exclusively different combinations under a condition that only antenna is actively coupled with one corresponding signal or transmission unit in each of said combinations.

14. A dual-mode wireless communication module adapted to be installed in an electronic device to communicate with other electronic devices, comprising:
an interface unit adapted to electrically connect with the electronic device;
a dual-mode base-band IC chip unit coupled to the interface unit;
a dual-mode radio frequency (RF) IC chip unit coupled to the base-band IC chip unit;
an RF front-end unit coupled to the RF IC chip unit, the RF front-end unit having two signal transmitting paths and two receiving paths and a switch unit having antenna selection diversity; and
two dual-band antennas coupled to the RF front-end unit.

15. The dual-mode wireless communication module as claimed in claim 14, wherein the switch unit has antenna selection diversity on the signal receiving path.

16. The dual-mode wireless communication module as claimed in claim 14, wherein the operation frequencies of the first and second dual-band antennas cover 2.4-2.4835 GHz and 5.15-5.825 GHz.
